(19) United States
(12) Patent Application Publication
(10) Pub. No.: US 2023/0398702 A1
(43) Pub. Date: Dec. 14, 2023

(54) OBJECT-SERVING DEVICE

(71) Applicant: TECHMAGIC K.K., Tokyo (JP)

(72) Inventor: Ryosuke TAJIMA, Tokyo (JP)

(21) Appl. No.: 18/033,092

(22) PCT Filed: Oct. 29, 2021
(86) PCT No.: PCT/JP2021/040155

§ 371 Date: Apr. 21, 2023

(30) Foreign Application Priority Data
Nov. 5, 2020 (JP) 2020-185381
Mar. 31, 2021 (JP) 2021-062456

(51) Int. Cl. B25J 15/10; B25J 15/00

(52) U.S. Cl. CPC B25J 15/10; B25J 15/0033; B25J 15/0004

(57) ABSTRACT

To provide an object-serving device that is capable of serving a predetermined amount of object with reduced damage to the object. An embodiment of the present invention provides an object-serving device, comprising: object-holding members configured to move at least between an object-holding position and an object release position; a base body to which the object-holding members are attached such that the object-holding members can be moved; and a drive mechanism for driving the object-holding members, wherein each of the object-holding members has a shape following its path of movement at the object-holding position.

### TECHNICAL FIELD

The present invention relates to an object-serving device for serving an object.

### BACKGROUND ART

In recent years, there has been a demand for automating processes of restaurant operations and services due to a shortage of restaurant employees. There is also a demand for automating work for serving food. The techniques shown in Patent Documents 1 to 3 have been proposed.

Patent Document 1 discloses multi-finger hand 30. Fingers 32 are inserted into food, and a part of the food is pinched and held by the side portions of the fingers 32.

Patent Document 2 discloses robot hand 1. Six finger links 20 are inclined such that a tip portion 23 intersects a plane passing a base end portion 21 and an intermediate portion 22. The six finger links 20 are inserted into a holding target such as food, and thereafter the distances between the side portions of the six finger links 20 are reduced. As a result, the holding target is sandwiched and held by the six finger links 20.

Patent Document 3 discloses object-holding device 1. Holding members 9A, 9B, and 9C are bent such that a tip portion faces central axis C. The holding members 9A, 9B, and 9C are pressed by pressing portion 7 and inserted into objects S such as food, having a high density. After that, the distances between the side portions of the holding members 9A, 9B, and 9C are reduced. As a result, objects S are sandwiched and held by the side portions of the holding members 9A, 9B, and 9C.

### PRIOR ART DOCUMENT

### Patent Document

Patent Document 1: JP-A-2019-25646
Patent Document 2: JP-A-2019-118999
Patent Document 3: JP-A-2019-135073

### SUMMARY OF THE INVENTION

### Problem to be Solved by the Invention

In the above-described Patent Document 1, the food is pressed by the side portions of the fingers 32, so that the food may be damaged by the side portions of the fingers 32.

In the above-described Patent Document 2, the holding target such as food is pressed by the side portions of the finger links 20, so that the holding target such as food may be damaged by the side portions of the finger links 20.

In the above-described Patent Document 3, objects S such as food is pressed by the side surfaces of the holding members 9A, 9B, and 9C, so that objects S such as food may be damaged by the side portions of the holding members 9A, 9B, and 9C.

An object of the present invention is to provide an object-serving device that is capable of serving a predetermined amount of object with reduced damage to the object.

### Means for Solving the Problem

The above object of the present invention can be achieved by the following configuration. A first embodiment of the present invention provides an object-serving device, comprising: object-holding members configured to move at least between an object-holding position and an object release position;
a base body to which the object-holding members are attached such that the object-holding members can be moved; and
a drive mechanism for driving the object-holding members,
wherein each of the object-holding members has a shape following its path of movement at the object-holding position.

A second embodiment of the present invention provides an object-serving device, which is the object-serving device of the first embodiment, wherein the shape of the object-holding members comprises at least one of a substantially arcuate shape or a substantially linear shape.

A third embodiment of the present invention provides an object-serving device, which is the object-serving device of the second embodiment, wherein at least two or more of the object-holding members are configured to move together.

A fourth embodiment of the present invention provides an object-serving device, which is the object-serving device of one of the first to third embodiments, wherein the base body is provided with an object-removing member having holding member insert holes into which the object-holding members are inserted from a tip to a base end.

### Effects of the Invention

An embodiment of the present invention is capable of serving a predetermined amount of object with reduced damage to the object.

### BRIEF DESCRIPTION OF THE DRAWINGS

FIG. 1 is a perspective view of an object-serving device according to embodiment 1 of the present invention.

FIG. 2 is a diagram illustrating the object-serving device being at an object-holding position illustrated in FIG. 1, which device is in a process of transition to an object release position.

FIG. 3 is a perspective view of the object-serving device viewed from above.

FIG. 4A is a side view of the object-serving device.

FIG. 4B is a B-B sectional view of the object-serving device shown in FIG. 4A.

FIG. 5A is a diagram illustrating an operation of the object-serving device.

FIG. 5B is a diagram illustrating the operation of the object-serving device.

FIG. 5C is a diagram illustrating the operation of the object-serving device.

FIG. 5D is a diagram illustrating the operation of the object-serving device.

FIG. 5E is a diagram illustrating the operation of the object-serving device.

FIG. 5F is a diagram illustrating the operation of the object-serving device.

FIG. 6A diagram is a diagram illustrating an operation of an object-serving device according to embodiment 2 of the present invention.

FIG. 6B diagram is a diagram illustrating the operation of the object-serving device according to embodiment 2 of the present invention.

FIG. 6C diagram is a diagram illustrating the operation of the object-serving device according to embodiment 2 of the present invention.

FIG. 6D diagram is a diagram illustrating the operation of the object-serving device according to embodiment 2 of the present invention.

FIG. 6E diagram is a diagram illustrating the operation of the object-serving device according to embodiment 2 of the present invention.

FIG. 6F diagram is a diagram illustrating the operation of the object-serving device according to embodiment 2 of the present invention.

FIG. 7 is a perspective view of an object-serving device according to embodiment 3 of the present invention.

FIG. 8 is a perspective view of the object-serving device viewed from above.

FIG. 9 is a perspective view of an object-serving device according to embodiment 4 of the present invention.

### DETAILED DESCRIPTION OF THE EMBODIMENTS

Object-serving devices according to embodiments of the present invention will be described below with reference to the drawings. It is of note that the following embodiments are examples of an object-serving device for realizing the technical idea of the present invention. The present invention is not limited to these embodiments and is equally applicable to other embodiments included in the scopes of the claims.

### Embodiment 1

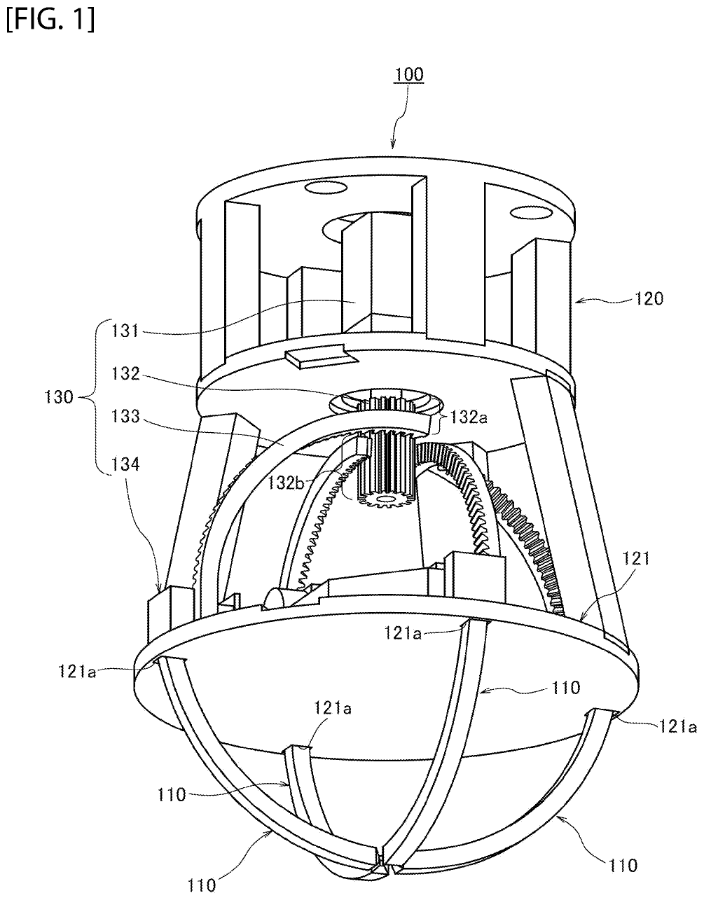

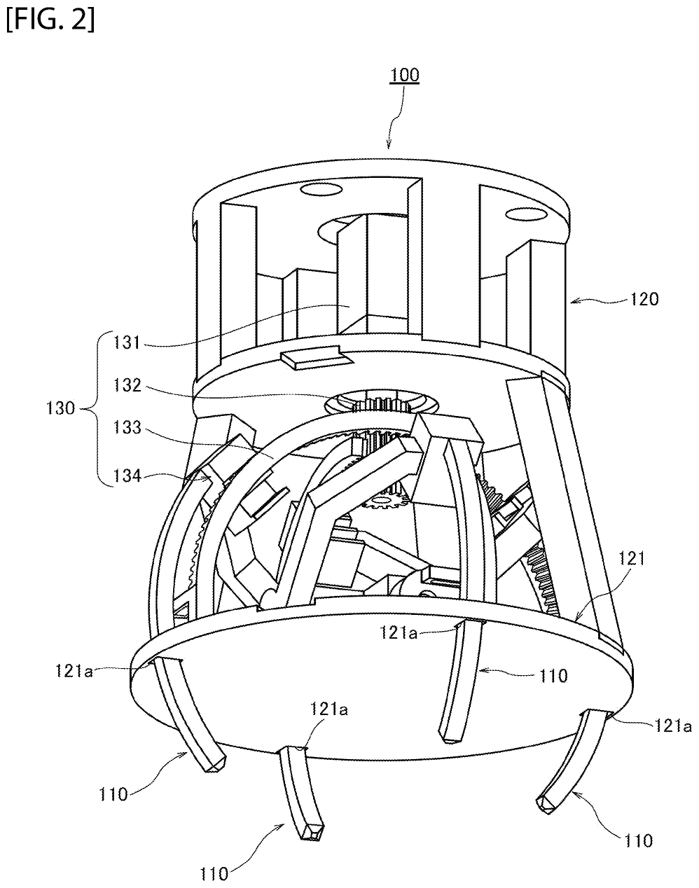

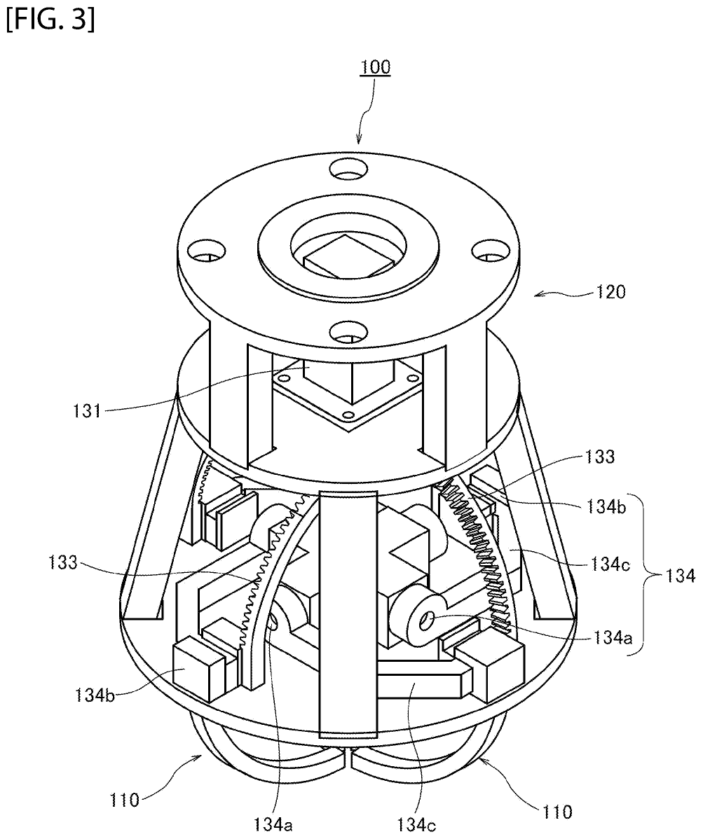

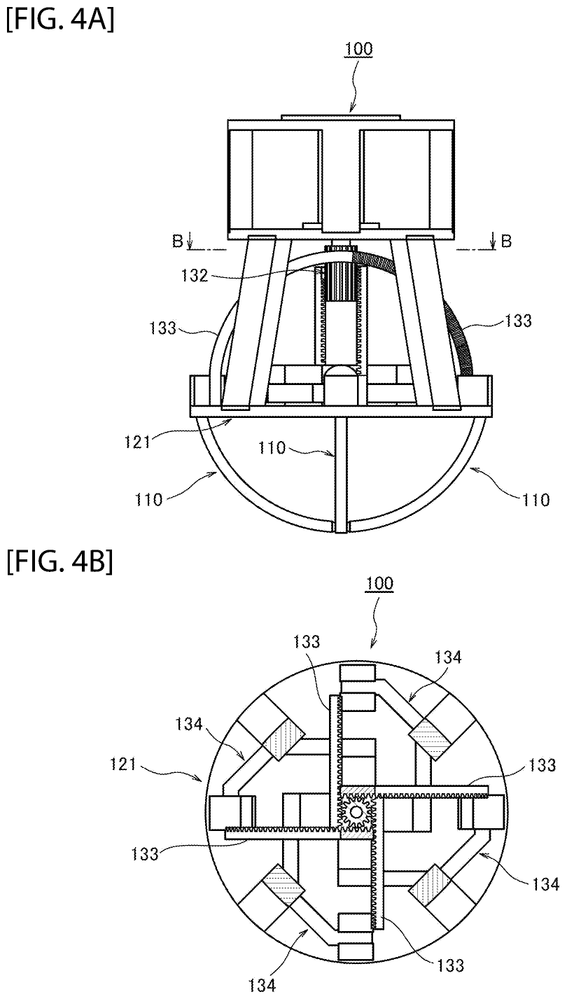

An object-serving device according to embodiment 1 of the present invention will be described with reference to FIG. 1 to FIG. 4. FIG. 1 is a perspective view of an object-serving device according to embodiment 1 of the present invention. FIG. 2 is a diagram illustrating the object-serving device being at an object-holding position illustrated in FIG. 1, which is in a process of transition to an object release position. FIG. 3 is a perspective view of the object-serving device viewed from above. FIG. 4A is a side view of the object-serving device. FIG. 4B is a B-B sectional view of the object-serving device shown in FIG. 4A.

It is of note that FIGS. 1 and 2 show the object-serving device, whose support constituting a base portion has been removed, to make a drive mechanism more visible.

The object-serving device of the present embodiment may take any shape as long as the device includes: object-holding members configured to move at least between an object-holding position and an object release position; a base body to which the object-holding members are attached such that the object-holding members can be moved; and a drive mechanism for driving the object-holding members, and each of the object-holding members has a shape following its path of movement at the object-holding position.

The object-serving device of the present embodiment functions better when the device is attachable to, for example, the end of an arm of a horizontal articulated robot or a vertical articulated robot.

It is of note that the object-serving device functions better when the device of the present embodiment is attached to a robot that is capable of rotating the device about the axis of the device.

The object-serving device of the present embodiment functions better when the device is used to serve sticky food such as potato salad or miso, or food such as shredded cabbage or burdock salad, which is a collection of finely divided pieces and can be easily held as a tangled lump. Objects to be served are not limited to those foods.

Objects to be served may include objects other than food. The object-serving device of the present embodiment is effective for a sticky or tangled material such as fibers, cotton, gel, or clay.

In a case where the object-serving device of the present invention is used for serving food, the exposed portion of the device is preferably made of a stainless steel. However, the exposed portion may be made of a material corresponding to an object to be served, other than stainless steel, such as a resin suitable for food.

Object-serving device 100 of the present embodiment includes: four object-holding members 110 configured to move at least between an object-holding position and an object release position; base body 120 to which the four object-holding members 110 are attached such that the object-holding members can be moved; and drive mechanism 130 for driving the four object-holding members 110.

It is of note that object-serving device 100 of the present embodiment is an example of a device including four object-holding members 110. The number of object-holding members 110 may be any number other than four as long as object-holding members 110 can hold an object. For example, the number of object-holding members 110 may be six.

Initially, the four object-holding member 110 of object-serving device 100 of the present embodiment will be described in detail.

Since the shapes of the four object-holding members 110 are similar, one of the object-holding members 110 will be described.

Object-holding member 110 is, for example, a stainless-steel square bar. The member is not limited to such a bar. Object-holding member 110 has a shape following a path of movement of the member at an object-holding position.

In the present embodiment, the path of movement of object-holding member 110 has a substantially arc shape. Object-holding member 110 has an arc shape following a path of movement of the member at an object-holding position.

Object-holding member 110 is not limited to a square bar and may be a round bar. The member may be tapered from the base end toward the tip.

Tapered object-holding member 110, for example, includes a thin tip to be inserted into food, and has a diameter gradually increasing from the tip toward the base portion, so that the tip of the member is easily inserted into food. The four object-holding members 110 include sufficiently thick base portions, so that the distances between the object-holding members 110 are narrow at an object-holding position, enough not to drop a held object.

It is of note that object-holding member 110 does not necessarily have to be gradually tapered. For example, object-holding member 110 may include a base-side portion having a predetermined length and a constant large-diameter, and a tip-side portion having a diameter gradually decreasing toward the tip. In a case where object-holding member 110 is configured to have a diameter gradually increasing from the tip toward the base portion, the rate of increase need not be limited.

The four object-holding members 110 may have a substantially rectangular cross-sectional shape; however, the present embodiment is not limited to the shape. The members may have any other cross-sectional shape such as a substantially polygonal shape, a substantially circular shape, or a substantially elliptical shape.

Now, base body 120 of object-serving device 100 of the present embodiment will be described in detail.

Base body 120 is made of, for example, a stainless-steel. The material of the body is not limited to a stainless steel. Base body 120 constitutes an exterior, which includes a frame onto which parts of object-serving device 100 such as the object-holding members 110 and drive mechanism 130 are mounted.

Base body 120 includes a portion to be fixed to a robotic arm, and object-removing member 121.

Object-removing member 121 is a plate-shaped member having four holding member insert holes 121a, into which the four object-holding members 110 are inserted from the tip to the base end when the members are moved between an object-holding position and an object release position.

More specifically, object-removing member 121 is a disk-shaped member connected to the portion of base body 120 that is to be fixed to a robotic arm. The member moves relatively to the four object-holding members 110 when the object-holding members are inserted into the holding member insert holes 121a and make a movement to an object-holding position and make a movement to an object release position, which is a movement opposite to the movement to an object-holding position. Object-removing member 121 has a side facing a surrounded space, which is a space in which an object is surrounded and held. The surrounded space is formed by the four object-holding members 110 being at an object-holding position. Object-removing member 121 has the other side on which four rotation support arms 134 of drive mechanism 130 are provided. Object-removing member 121 is made of, for example, a stainless-steel or a resin suitable for food. The material of the member is not limited to those material. A resin suitable for food includes, for example, a polyacetal resin, a PEEK resin, and a PPSU resin, which conform to the food standard. An appropriate resin may be selected in consideration of chemical resistance and heat resistance.

Now, drive mechanism 130 of object-serving device 100 of the present embodiment will be described in detail.

Drive mechanism 130 includes: motor 131; pinion gear 132 connected to motor 131; two pairs of (four) connection gears 133 engaged with pinion gear 132 at different positions in the axial direction of pinion gear 132; and four connection gears 133 for connecting four connection gears 133 and the four object-holding members 110. Each of the four connection gears 133 has an arc shape and is connected to object-holding member 110 as described later.

Pinion gear 132 is made of, for example, a stainless-steel. The material of the gear is not limited to a stainless steel. Pinion gear 132 has such a length that each pair of four arc-shaped connection gears 133 can engage with pinion gear 132 at neighboring different positions in the axial direction of pinion gear 132. Pinion gear 132 has such a length that the engagement area is divided into upper and lower areas. One of the two areas is upper engagement area 132a in which two opposing connection gears 133, which have teeth facing pinion gear 132, are engaged with pinion gear 132. The other is lower engagement area 132b in which the other two opposing connection gears 133, which have teeth facing pinion gear 132, are engaged with pinion gear 132.

At an upper position shown in FIG. 1, pinion gear 132 is engaged with a pair of connection gears 133 of upper engagement area 132a, which gears face each other across the center of pinion gear 132. At a lower position shown in FIG. 1 than the engagement position of the pair of connection gears 133 of upper engagement area 132a, pinion gear 132 is engaged with a pair of connection gears 133 of lower engagement area 132b, which gears face each other across the center of pinion gear 132. The position where the pair of connection gears 133 of upper engagement area 132a engage with pinion gear 132 and the position where the pair of connection gears 133 of lower engagement area 132b engage with pinion gear 132 are different by approximately 90 degrees when viewed from above in FIG. 1 (or, from above the central shaft of pinion gear 132). In other words, the positions at which connection gear 133 engages with pinion gear 132 are different by about 90 degrees from each other.

Accordingly, pinion gear 132 works as a main gear, and four connection gears 133 work as driven gears.

The four connection gears 133 are made of, for example, a stainless-steel. The material of the gears is not limited to a stainless steel. The position where the pair of connection gears 133 of upper engagement area 132a are engaged with pinion gear 132 and the position where the pair of connection gear 133 of lower engagement area 132b are engaged with pinion gear 132 are different in the central-axial direction of pinion gear 132. However, the connection gears 133 are connected to the four object-holding members 110, which have a similar range of movement. The object-holding members 110 protrude most at object-holding position P1, at which the members are substantially in contact with each other or almost come into contact with each other. The object-holding members 110 simultaneously reach object-holding position P1.

Whether at object-holding position P1, the tips of the object-holding members 110 are substantially in contact with each other or almost come into contact with each other relates to the shape of the tips of the object-holding members 110. The tips of the object-holding members 110 may have such a shape that when the four members are in contact with each other, the tips, in combination, fill the central space formed by the members being in contact with each other. Alternatively, the tips may have such a shape that the tips do not fill the central space formed by the members being in contact with each other.

The object-holding members 110 protrude least at object release position P2. The object-holding members 110 protrude by the same amount at object release position P2 and reach object release position P2 at the same time.

It is of note that the object-holding members 110 preferably protrude by the same amount at object-holding position P1; in contrast, the object-holding members 110 may protrude by a different amount at object release position P2. For example, object-holding members 110 connected to the pair of connection gears 133 of upper engagement area 132a, and object-holding members 110 connected to the pair of connection gears 133 of lower engagement area 132b may protrude by a different amount at object release position P2.

The rotation support arms 134 are made of, for example, a stainless-steel. The material of the arms is not limited to a stainless-steel. Each of the rotation support arms 134 incudes: rotation support shaft portion 134a that is a rotation support shaft for arc-shaped connection gear 133 that is rotated via pinion gear 132; connecting portion 134b for connecting connection gear 133 and the base end portion of object-holding member 110; and arm portion 134c for connecting rotation support shaft portion 134a and connecting portion 134b.

The rotation support shaft portions 134a of the four rotation support arms 134 are provided such that the axial direction of the portions is perpendicular to the axial direction of pinion gear 132, and that the rotational centers of two rotation support shaft portions 134a are concentric, which portions correspond to a pair of connection gears 133 engaged in upper or lower engagement area 132a or 132b.

The engagement positions of connection gears 133 and pinion gear 132 in upper and lower engagement areas 132a and 132b, the arc shapes of connection gears 133, the sizes and the arrangement of the rotation support shaft portions 134a, the connecting portions 134b, and the arm portions 134c are appropriately designed so that the four object-holding members 110 connected to the connection gears 133 have a similar range of movement, and the members make a synchronized movement.

Drive mechanism 130 described in the foregoing is provided such that the four object-holding members have 110 the base end portions at object-holding position P1, which portions are arranged on the spherical surface of a sphere substantially equal to the radius of the arc-shaped object-holding position, at intervals of approximately 90 degrees in a circumferential direction.

Drive mechanism 130 of the present embodiment may be provided with a detector (not shown) for detecting positions of the connection gears 133. Positions detected by the detector are associated with object-holding position P1 and object release position P2 of the four object-holding members 110.

Accordingly, a controller (not shown) of object-serving device 100 can perform position control of the four object-holding members 110 based on position information of the connection gears 133 detected by the detector. For example, the controller can control motor 131 to cause the four object-holding members 110 to stop at object-holding position P1 or object release position P2.

The detector may be a detector for directly detecting positions of connection gears 133. Alternatively, the detector may be a sensor for detecting a rotational speed of motor 131. Alternatively, the detector may be a detector for detecting a load current of motor 131. Alternatively, these different types of detectors may be provided.

For example, in a case where the detector includes a detector for detecting a load current of motor 131, it is possible to detect object-holding position P1 and object release position P2 based on an increase in the load current. In addition, by detecting an overcurrent of motor 131, it is possible to detect an overload anomaly and to emergency-stop motor 131. Further, it is possible to perform velocity control according to positions of the object-holding members 110. As another example, in a case where a sensor is provided for directly or indirectly detecting a rotational speed of motor 131, it is possible to control a speed of the object-holding members 110 more precisely.

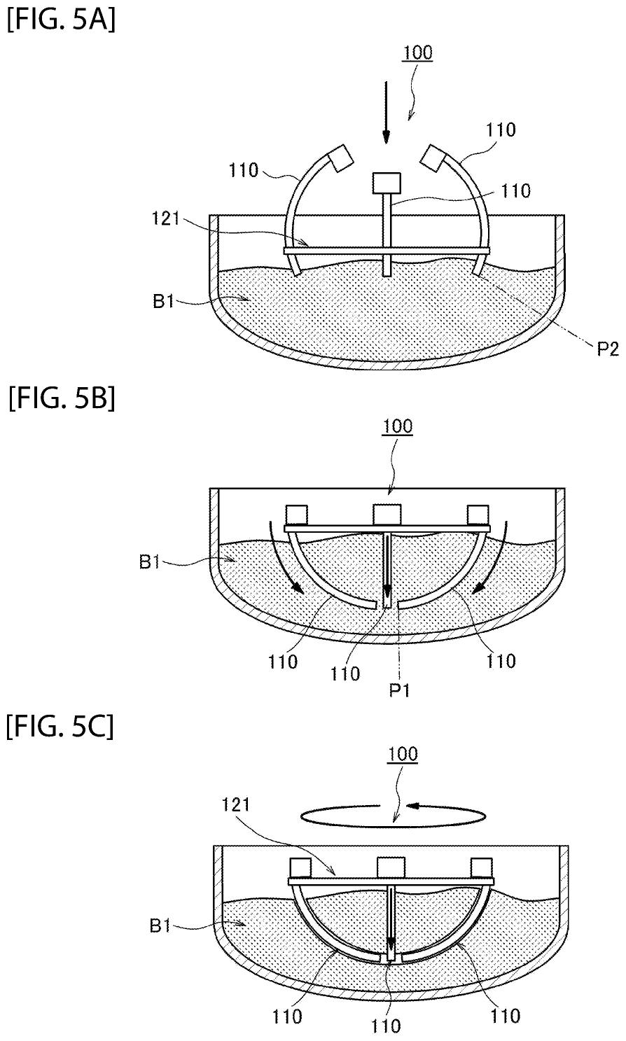

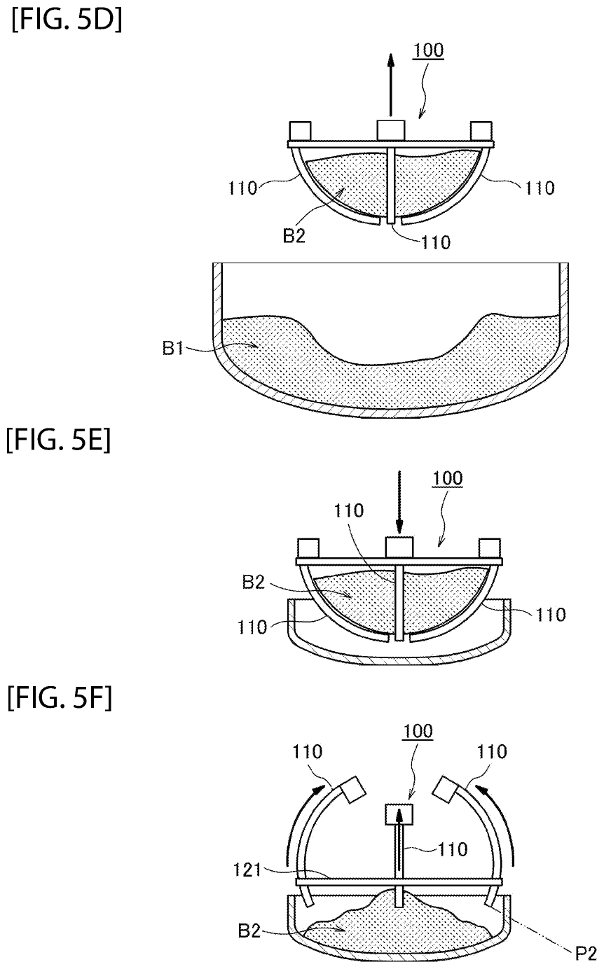

Now, an object-serving operation of object-serving device 100 will be described with reference to FIGS. 5A to 5F.

The following description assumes that object-serving device 100 is attached to an end of an arm of, for example, a horizontal articulated robot or a vertical articulated robot, and is controlled by a control device of the robot. However, a type of robot arm of the present embodiment is not limited to those robot arms. The present embodiment can be applied to various types of robot arms.

FIG. 5 shows object-serving device 100 viewed from a position at which one object-holding member 110 being in front is seen; therefore, the figure shows only three object-holding members 110. However, the other object-holding member 110 exists behind the object-holding member 110 being in front.

Initially, object-serving device 100 is in a state that the four object-holding members 110 are at object release position P2 for accepting an object. The device is moved downward from a position above object B1 to be served, toward object B1 to be served (refer to FIG. 5A).

Object-serving device 100 that has been moved downward toward object B1 to be served has the four object-holding members 110 arranged at a position where the members can be inserted into object B1 to be served.

Subsequently, four object-holding members 110 of object-serving device 100 are moved from object release position P2 to object-holding position P1 (refer to FIG. 5B).

The four object-holding members 110 of object-serving device 100 are simultaneously moved in different directions to be inserted into object B1 to be served.

When the movement is made, the four connection gears 133 engaged with one pinion gear 132 cause the four object-holding members 110 to move together.

The four object-holding members 110 are simultaneously inserted in different directions into object B1 to be served, and further moved so that the tips of the members are arranged close to each other at object-holding position P1. At the position, the four object-holding members 110 form a surrounded space in which a predetermined amount of object B2 is held.

More specifically, after the four object-holding members 110 has moved to object-holding position P1, the base end portions of the members are arranged on the spherical surface at intervals of approximately degrees in a circumferential direction. In addition, the tips are directed substantially laterally, and arranged close to each other. As a result, the four object-holding members 110 form a hemispherical surrounded space in which a predetermined amount of object B2 is held.

In short, the four object-holding members 110 are moved only in the insertion direction toward object B1 to be served; as a result, the members form a surrounded space in which a predetermined amount of object B2 is held.

The object-holding members 110 have an arc-shaped path of movement. The four arc-shaped object-holding members 110 move along an arc-shaped path of movement.

Substantially the entirety of object-holding member 110 from the tip to the back end is moved along an arc-shaped path of movement; as a result, the member is moved from object release position P2 to object-holding position P1. Object-holding member 110 is shaped at object-holding position P1 such that the member follows a path of movement of the member, so that the tip of the member is inserted into the object by a point. When the insertion is made, the side surface of object-holding member 110 does not exert any force to press the object.

Therefore, the movements of the four object-holding members 110 from object release position P2 to object-holding position P1 are similar to an action of surrounding an object with human fingers and gently holding the object.

Therefore, object-serving device 100 can hold a predetermined amount of object with the four object-holding members 110, without damaging the object.

Subsequently, object-serving device 100 is rotated about the axis of the device (refer to FIG. 5C).

The rotation of object-serving device 100 about its axis separates object B2 included in the surrounded space surrounded by the four object-holding members 110, from the object being outside the surrounded space.

Object-serving device 100 may be rotated about its axis in one direction or in forward and backward directions. The rotation angle may be determined as appropriate. In a case where the device is rotated in forward and backward directions, the device may make plural times of reciprocating movements.

Subsequently, object-serving device 100 is moved upward with a predetermined amount of object B2 held by the four object-holding members 110 (refer to FIG. 5D), and then moved to the destination (refer to FIG. 5E).

Assuming that the object is food such as potato salad, the destination is, for example, a dish for serving the food to a customer.

Lastly, the four object-holding members 110 of object-serving device 100 are moved from object-holding position P1 to object release position P2, and thereafter the predetermined amount of object B2 is put into the destination (refer to FIG. 5F).

After the four object-holding members 110 are moved from object-holding position P1 to object release position P2, substantially the entirety of each of the members from the tip to the base end is inserted into holding member insert hole 121a. As a result, an object attached to object-holding member 110 is brought into contact with the surface of object-removing member 121 facing the surrounded space so that the object comes off.

Object-serving device 100 can remove objects attached to the four object-holding members 110, without moving object-removing member 121 using by a drive mechanism or the like, in a series of operations by which the object-holding members 110 are moved from object-holding position P1 to object release position P2 relative to object-removing member 121.

As described in the foregoing, object-serving device 100 of the present embodiment includes: the four object-holding members 110 configured to move at least between object-holding position P1 and object release position P2; base body 120 to which the four object-holding members 110 are attached such that the members can be moved; and drive mechanism 130 for driving the four object-holding members 110. The four object-holding members 110 are moved to object-holding position P1 in different directions, and each of the members is shaped at object-holding position P1 such that the member follows a path of movement of the member. Accordingly, when the four object-holding members 110 are moved to object-holding position P1 along a path of movement, a surrounded space is formed by the inserted members, in which a predetermined amount of object B2 is held. In addition, when the four object-holding members 110 are moved to object release position P2, the held object is released. Accordingly, the four object-holding members 110 can hold the predetermined amount of object B2 and release it into the destination, without holding and pressing the object by the sides of the members. As a result, object-serving device 100 can serve the predetermined amount of object B2 with reduced damage to the object.

The shape of the four object-holding members 110 includes a substantially arc shape so that the members are inserted into an object to be served, in a wide and shallow manner, along an arc-shaped path of movement. The tips of the members are directed substantially laterally and arranged close to each other so that a hemispherical surrounded space is formed in which a predetermined amount of object B2 is held. Accordingly, when repeatedly serving object B2 to be served, with the four object-holding members 110, object-serving device 100 of the present embodiment can minimize the variation in the depth of the object. As a result, object-serving device 100 can minimize the variation in the amount of the object held by the four object-holding members 110.

The four object-holding members 110 are moved between object-holding position P1 and object release position P2 by drive mechanism 130. One pinion gear 132 of drive mechanism 130 works as a main gear and the four connection gears 133 work as driven gears so that the four object-holding members 110 are caused to move together. Accordingly, object-serving device 100 of the present embodiment includes a simple structure as drive mechanism 130 for the four object-holding members 110.

Base body 120 includes plate-like object-removing member 121, which has the four holding member insert holes 121a. The insert holes allow the four object-holding members 110 to be inserted from its tip to its base end when the members are moved between object-holding position P1 and object release position P2. After the four object-holding members 110 are moved from object-holding position P1 to object release position P2, each of the members from the tip to the base end is inserted into holding member insert hole 121a. As a result, an object attached to object-holding member 110 is brought into contact with the surface of object-removing member 121 facing the surrounded space in which an object is held, so that the object comes off. Accordingly, object-serving device 100 of the present embodiment ensures serving of a predetermined amount of object B2 held by the four object-holding members 110 to the destination.

### Embodiment 2

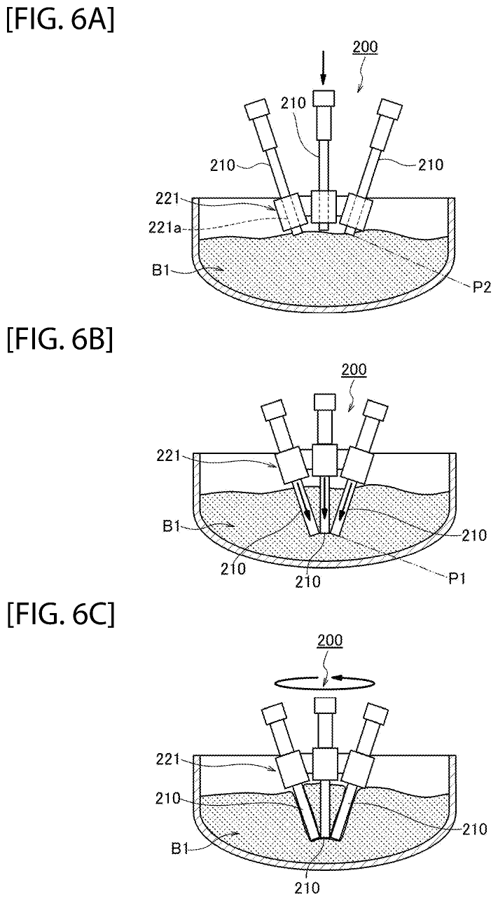

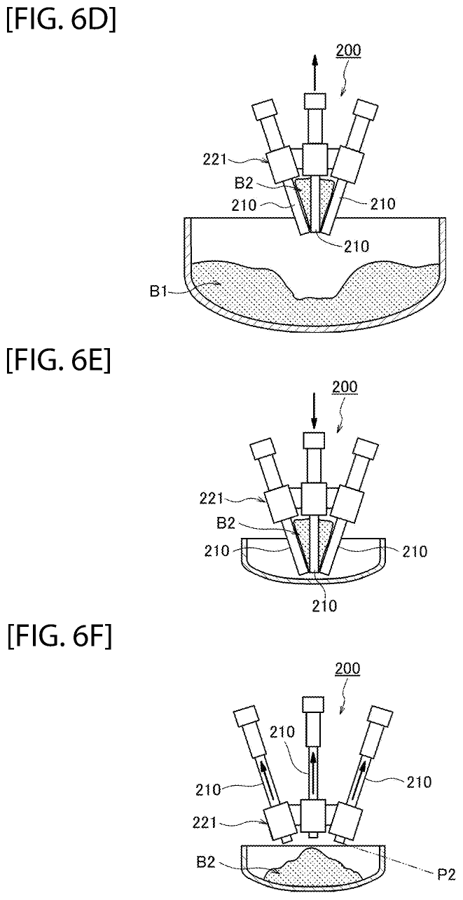

Object-serving device 200 according to embodiment 2 of the present invention will be described with reference to FIG. 6. FIGS. 6A to 6F are diagrams illustrating an operation of object-serving device 200 according to embodiment 2 of the present invention.

Object-serving device 200 according to embodiment 2 of the present invention differs from the above-mentioned object-serving device 100 according to embodiment 1 of the present invention in the shape of four object-holding members 210, the shape of base body 220, and the configuration of the drive mechanism (not shown) for driving the four object-holding members 210. However, object-serving device 200 shares the other configurations with object-serving device 100. The portions and members shared with object-serving device 100 are denoted by corresponding reference numerals in the 200s, and redundant explanation thereof will be omitted.

Initially, the four object-holding members 210 of object-serving device 200 of the present embodiment will be described in detail.

Object-holding member 210 is, for example, a stainless-steel round bar. The member is not limited to such a bar. Object-holding member 210 has a linear shape following a path of movement of the member at object-holding position P1.

Now, base body 220 of object-serving device 200 of the present embodiment will be described in detail.

Base body 220 (not shown) is made of, for example, a stainless-steel. The material of the body is not limited to a stainless steel. Base body 220 constitutes an exterior, which includes a frame onto which parts of object-serving device 200 such as the object-holding members 210 and the drive mechanism are mounted.

Base body 220 includes a portion (not shown) to be fixed to a robotic arm, and object-removing member 221.

Object-removing member 221 is a block-shaped member having four holding member insert holes 221a, into which the four object-holding members 210 are inserted from the tip to the base end when the members are moved between object-holding position P1 and object release position P2.

More specifically, object-removing member 221 is a member connected to the portion of base body 220 that is to be fixed to a robotic arm. The member moves relatively to the four object-holding members 210 when the object-holding members are inserted into the holding member insert holes 221a and make a movement to object-holding position P1 and make a movement to object release position P2, which is a movement opposite to the movement to object-holding position P1.

Now, the drive mechanism (not shown) of object-serving device 200 of the present embodiment will be described.

The drive mechanism of object-serving device 200 of embodiment 2 is, for example, a linear actuator such as a cylinder. The drive mechanism is not limited to a linear actuator. The drive mechanism is connected to the four object-holding members 210 to cause the members to move between object-holding position P1 and object release position P2. It is of note that the drive mechanism is not limited to a linear actuator, and may be, for example, a link mechanism.

Now, an object-serving operation of object-serving device 200 will be described with reference to FIGS. 6A to 6F.

The following description assumes that object-serving device 200 is attached to an end of an arm of, for example, a horizontal articulated robot or a vertical articulated robot, and is controlled by a control device of the robot. However, the present embodiment is not limited to those robot arms. The present embodiment can be applied to various types of robot arms.

FIG. 6 shows object-serving device 200 viewed from a position at which one object-holding member 210 being in front is seen; therefore, the figure shows only three object-holding members 210. However, the other object-holding member 210 exists behind the object-holding member 210 being in front.

Initially, object-serving device 200 is in a state that the four object-holding members 210 are at object release position P2 for accepting an object. The device is moved downward from a position above object B1 to be served, toward object B1 to be served (refer to FIG. 6A).

Object-serving device 200 that has been moved downward toward object B1 to be served has the four object-holding members 210 arranged at a position where the members can be inserted into object B1 to be served.

Subsequently, the four object-holding members 210 of object-serving device 200 are moved from object release position P2 to object-holding position P1 (refer to FIG. 6B).

The four object-holding members 210 of object-serving device 200 are simultaneously moved in different directions to be inserted into object B1 to be served.

The four object-holding members 210 are inserted into object B1 to be served, and further moved so that the tips of the members are arranged close to each other at object-holding position P1. At the position, the four object-holding members 210 form a surrounded space in which a predetermined amount of object B2 is held.

More specifically, after the four object-holding members 210 has moved to object-holding position P1, the base end portions of the members are arranged at intervals of approximately 90 degrees in a circumferential direction around the axis of object-serving device 200. In addition, the tips are arranged close to each other. As a result, the four object-holding members 210 form a surrounded space in which a predetermined amount of object B2 is held.

The four object-holding members 210 are moved only in the insertion direction toward object B1 to be served; as a result, the members form a surrounded space in which a predetermined amount of object B1 is held.

The object-holding members 210 have a linear-shaped path of movement. The four linear-shaped object-holding members 210 move along a linear-shaped path of movement.

Substantially the entirety of object-holding member 210 from the tip to the back end is moved along a linear-shaped path of movement; as a result, the member is moved from object release position P2 to object-holding position P1. Object-holding member 210 has a shape following a path of movement of the member at object-holding position P1, so that the tip of the member is inserted into the object by a point.

Accordingly, the side surface of object-holding member 210 does not exert any force to press the object. Therefore, object-serving device 100 can hold a predetermined amount of object with the four object-holding members 110, without damaging the object.

Subsequently, object-serving device 200 is rotated about the axis of the device (refer to FIG. 6C), as in the case shown in FIG. 5C of embodiment 1.

The rotation of object-serving device 200 about its axis separates the object included in the surrounded space surrounded by the four object-holding members 210, from the object being outside the surrounded space.

Subsequently, object-serving device 200 is moved upward with a predetermined amount of object B2 held by the four object-holding members 210 (refer to FIG. 6D), and then moved to the destination (refer to FIG. 6E).

Assuming that the object is food such as potato salad, the destination is, for example, a dish for serving the food to a customer.

Lastly, the four object-holding members 210 of object-serving device 200 are moved from object-holding position P1 to object release position P2, and thereafter the predetermined amount of object B2 is put into the destination (refer to FIG. 6F).

After the four object-holding members 210 are moved from object-holding position P1 to object release position P2, substantially the entirety of each of the members from the tip to the base end is inserted into holding member insert hole 221a. As a result, an object attached to object-holding member 210 is brought into contact with the surface of object-removing member 121 facing the surrounded space surrounded by the four object-holding members 210, so that the object comes off.

As described in the foregoing, object-serving device 200 of the present embodiment includes: the four object-holding members 210 configured to move at least between object-holding position P1 and object release position P2; base body 220 to which the four object-holding members 210 are attached such that the members can be moved; and drive mechanism 230 for driving the four object-holding members 210. The four object-holding members 210 are moved to object-holding position P1 in different directions, and each of the members has a shape following its path of movement at object-holding position P1. Accordingly, when the four object-holding members 210 are moved to object-holding position P1 along a path of movement, a surrounded space is formed by the inserted members, in which a predetermined amount of object B2 is held. In addition, when the four object-holding members 210 are moved to object release position P2, the held object is released. Accordingly, the four object-holding members 210 can hold the predetermined amount of object B2 and release it into the destination, without holding and pressing the object by the sides of the members. As a result, object-serving device 200 can serve the predetermined amount of object B2 with reduced dame to the object.

### Embodiment 3

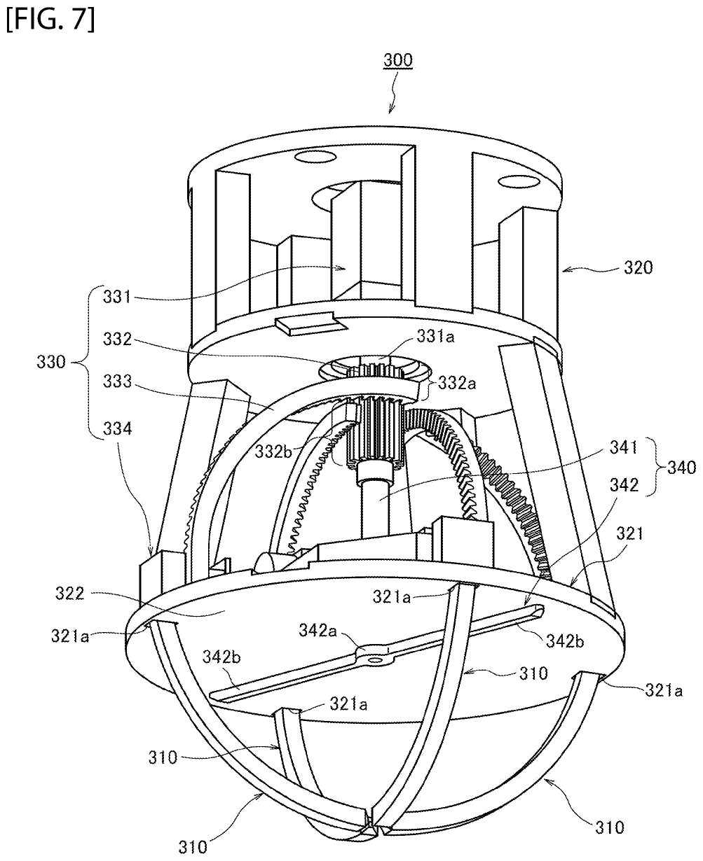

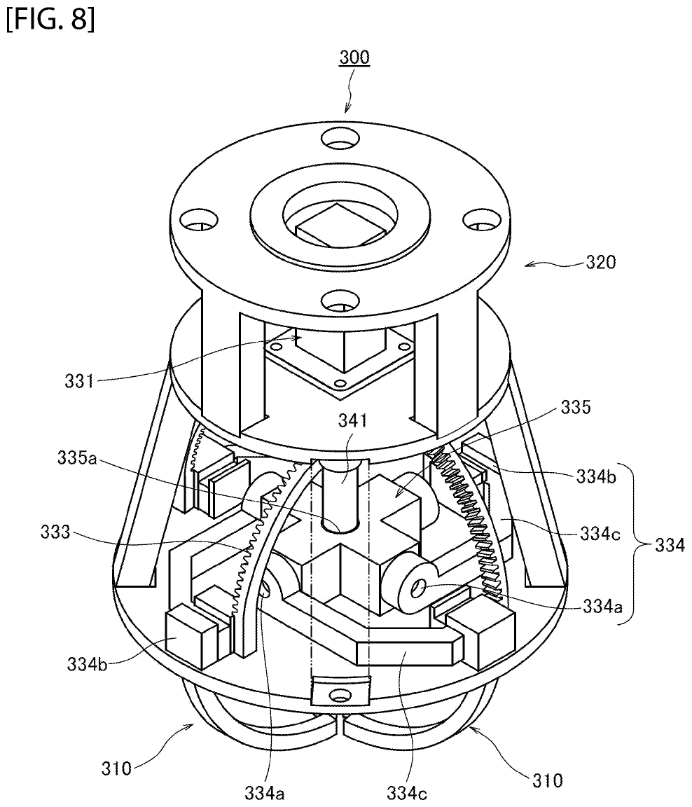

Object-serving device 300 according to embodiment 3 of the present invention will be described with reference to FIGS. 7 and 8. FIG. 7 is a perspective view of object-serving device 300 according to embodiment 3 of the present invention. FIG. 8 is a perspective view of object-serving device 300 viewed from above.

It is of note that FIG. 8 shows object-serving device 300, whose support constituting base portion 320 has been removed, to make drive mechanism 330 more visible.

Object-serving device 300 according to embodiment 3 of the present invention differs from the above-mentioned object-serving device 100 according to embodiment 1 of the present invention in that object-serving device 300 further includes object-sweeping mechanism 340 for sweeping away an object attached to the device. However, object-serving device 300 shares the other configurations with object-serving device 100. The portions and members shared with object-serving device 100 are denoted by corresponding reference numerals in the 300s, and redundant explanation thereof will be omitted.

Object-serving device 300 of the present embodiment includes: four object-holding members 310 configured to move at least between object-holding position P1 and object release position P2; base body 320 to which the four object-holding members 310 are attached such that the object-holding members can be moved; drive mechanism 330 for driving the four object-holding members 310; and object-sweeping mechanism 340.

It is of note that object-serving device 300 of the present embodiment is an example of a device including four object-holding member 310. The number of object-holding members 310 may be any number other than four as long as object-holding members 310 can hold an object. For example, the number of object-holding members 310 may be six.

In the present embodiment, the path of movement of object-holding member 310 has a substantially arc shape. Object-holding member 310 has an arc shape following a path of movement of the member at the object-holding position. It is of note that in the present embodiment, object-holding member 310 does not need to have a shape strictly following the three-dimensional path of movement of the member. The member, in consideration of the play, etc., may have a shape substantially following the path of movement of the member.

Object-serving device 300 of the present embodiment includes object-sweeping mechanism 340 that is interlocked with drive mechanism 330 to sweep away an object attached to base body 320. Object-sweeping mechanism 340 includes rotation shaft 341 that is interlocked with drive mechanism 330 for rotation, and rotation member 342 that is fixed at an end of rotation shaft 341, and rotated in accordance with a rotational movement of rotation shaft 341.

### <Rotation Shaft 341>

Rotation shaft 341 is made of, for example, a stainless-steel. The material of the shaft is not limited to a stainless steel. Rotation shaft 341 has a base end portion connected to the lower end portion of pinion gear 332, and a tip portion extending downward so as to protrude from the side (hereinafter, referred to as an “surrounded side”) of object-removing member 321 that faces the surrounded space in which an object is held.

More specifically, rotation shaft 341 protrudes from surrounded side 322 of object-removing member 321 through shaft block 335 (refer to FIG. 8) constituting rotation support shaft portions 334a for connection gears 333, and object-removing member 321.

At least one of shaft block 335 and object-removing member 121 is provided with bearing 335a that pivotally supports rotation shaft 341.

Rotation shaft 341 is connected to an end in the axial direction of pinion gear 332. The other end in the axial direction of pinion gear 332 is connected to shaft 331a of motor 331. Pinion gear 332 is supported at both ends so that the gear is stably rotated with suppressed eccentricity of the shaft. Pinion gear 332 and connection gears 333 easily engage with each other in a stable manner, so that object-serving device 300 allows a wide range of engagement size of the gears.

Object-serving device 300 of the present embodiment may be provided with four gear guide members (not shown) to maintain the engagement between connection gears 333 and pinion gear 332. The four gear guide members guide connection gears 333 in a direction to press the gears against pinion gear 332. The four gear guide members are provided at positions corresponding to portions of connection gears 333 facing pinion gear 332.

The gear guide members are plate-shaped members. The members are fixed to base body 320 such that the member faces pinion gear 332 across connection gear 333 engaged with pinion gear 332 for movement.

Each of the gear guide members supports the back side of corresponding connection gear 333 to prevent the gear from disengaging from pinion gear 332 due to load deflection of connection gear 333.

### <Rotation Member 342>

Rotation member 342 sweeps away an object attached to base body 320, from base body 320 by rotational movement.

It is of note that “sweeping” meant in the present invention is not intended to limit terms in particular. The “sweeping” means sweeping away an object attached to base body 320. The “sweeping” also means sweeping, scraping, peeling, or wiping off an object attached to base body 320 (more specifically, surrounded side 322 of object-removing member 321).

Rotational member 342 is made of, for example, a stainless-steel. The material of the member is not particularly limited to a stainless-steel. Rotational member 342 is rotatably fixed to rotation shaft 341 at a position where the member is in contact with surrounded side 322 or in proximity to surrounded side 322.

Rotation member 342 includes center fixing portion 342a fixed to an end of rotation shaft 341, and a pair of strip-like portions 342b extending in opposite directions from center fixing portion 342a toward opposite edges of object-removing member 321. Center fixing portion 342a serving as a rotational center, and the pair of strip-like portions 342b are formed linearly and integrally.

The pair of strip-like portions 342b are symmetrically arranged with respect to center fixing portion 342a serving as a rotational center.

In the present embodiment, rotation member 342, as a whole, has a shape of a long and thin blade. The both ends of the member have a tapering slope inclined downward toward the end face.

Object-sweeping mechanism 340 described in the foregoing includes: rotation shaft 341 that is rotated according to a rotational movement of pinion gear 332, which causes the four object-holding members 310 to move between object-holding position P1 and object release position P2; and rotation member 342 that is rotated according to a rotational movement of rotation shaft 341.

Rotation member 342 is interlocked with pinion gear 332 for rotation, which pinion gear causes the four object-holding members 310 to move between object-holding position P1 and object release position P2.

When the four object-holding members 310 are moved from object-holding position P1 to object release position P2 to release a held object, rotation member 342 is rotated according to a rotational movement of pinion gear 332 that is opposite to the rotation for the movement from object release position P2 to object-holding position P1.

In the present embodiment, when the four object-holding members 310 are moved between object-holding position P1 and object release position P2, pinion gear 332 is rotated, for example, 1.25 times. This number of rotations of pinion gear 332 may be changed to any other number, which can cause the four object-holding members 310 to move between object-holding position P1 and object release position P2. In a case where two strip-like portions 342b are used, pinion gear 332 is rotated by at least 180 degrees. In a case where four strip-like portions 342b are used, pinion gear 332 is rotated by at least 90 degrees. In a case where one strip-like portion 342b is used, pinion gear 332 is rotated by at least 360 degrees.

In the present embodiment, rotation member 342 is made of, for example, a stainless-steel material; however, the member may be made of any other material suitable for sweeping away an object attached to base body 320, which material includes another metal, a resin, a combination of a metal and a resin, a two-color molded resin, and an elastic material. For example, in a case where a combination of a metal and a resin is used, rotation member 342 may have a front side facing surrounded side 322, that is made of a resin having a low coefficient of friction, and a back side formed integrally with the front side, that is made of a metal. In a case where one of surrounded side 322 and rotation member 342 is made of a stainless-steel, the other may be made of a plastic suitable for food. In a case where the both are made of a stainless-steel, a small gap of, for example, 1 mm or less may be provided between them. To provide the gap, rotation shaft 341 of rotation member 342 may be pivotally supported by at least one of shaft block 335 and object-removing member 121 via bearing 335a.

In the present embodiment, rotation member 342 includes the pair of strip-like portions 342b extending in opposite directions from center fixing portion 342a toward opposite edges of object-removing member 321. The shape of rotation member 342 is not particularly limited to such a shape. The number of strip-like portions 342b may be any number that is equal to or larger than one. For example, the number of strip-like portions 342b may be increased to four, and four strip-like portions 342b may be provided at intervals of 90 degrees in the circumferential direction of center fixing portion 342a. It is of note that in a case where the number of strip-like portions 342b is too many, or the surface area of strip-like portions 342b is too large, an object easily attaches to strip-like portions 342b; accordingly, the number and the shape (such as a surface area) of strip-like portions 342b are limited depending on how sticky an object is.

In a case where rotation member 342 is provided with four strip-like portions 342b, rotation member 342 can, by a rotation of at least 90 degrees, cause plural strip-like portion 342b to rotate in such a manner that the portions complement each other's rotational angle areas. As a result, the four strip-like portions 342b sweep away an object attached to surrounded side 322, over substantially the entirety of surrounded side 322.

In a case where plural strip-like portions 342b are provided, pinion gear 332 can, by less than one rotation, cause the strip-like portions 342b to complement each other's rotational angle areas, thereby sweeping away an object attached to surrounded side 322.

In a case where pinion gear 332 is rotated by at least one revolution or more, one strip-like portion 342b can sweep away an object attached to surrounded side 322, over substantially the entirety of surrounded side 322. In that case, the number of strip-like portions 342b may be reduced from two to one.

As for object-sweeping mechanism 340 described in the foregoing, pinion gear 332 is rotated to cause the four object-holding members 310 to move between object-holding position P1 and object release position P2. The number of the rotation of pinion gear 332 may be adjusted by adjusting the gear ratio of pinion gear 332 and connection gears 333.

By appropriately adjusting the number of rotations of pinion gear 332, the shape of rotation member 342, the number of strip-like portions 342b, the arrangement of strip-like portions 342b, etc., object-sweeping mechanism 340 can sweep away an object attached to surrounded side 322.

Now, an object-serving operation of object-serving device 300 will be described.

Initially, object-serving device 300 is moved downward from a position above an object to be served, toward the object, so that the four object-holding members 310 are arranged at a position where the members can be inserted into the object.

After the four object-holding members 310 are arranged at a position where the members can be inserted into the object, the members are moved from object release position P2 to object-holding position P1.

The four object-holding members 310 are simultaneously moved to object-holding position P1 in different directions. When the object-holding members 110 are moved to object-holding position P1 along a path of movement, a surrounded space is formed by the inserted members, in which a predetermined amount of object B2 is held.

When the four object-holding members 110 are inserted into the object to be served, the four connection gears 333 engaged with one pinion gear 332 cause the four object-holding members 110 to move together. In addition, a rotational movement of pinion gear 332 causes rotation member 342 to rotate via rotation shaft 341.

As a result, rotation member 342 is rotated along the substantially entire surface of object-removing member 321 that faces the surrounded space, so that an object attached to surrounded side 322 is swept away.

Object-sweeping mechanism 340 includes rotation member 342 that is rotated when the four object-holding members 310 hold the object. This mechanism prevents the held object from attaching to surrounded side 322 of object-removing member 321.

Accordingly, a sticky object such as potato salad does not attach to object-removing member 321 which is part of base body 320, and is held in the hemispherical surrounded space formed by the four object-holding members 310.

Subsequently, object-serving device 300 is rotated about the axis of the device, as in the case of object-serving device 100 of embodiment 1 (refer to FIG. 5C). This rotation separates the object included in the surrounded space surrounded by the four object-holding members 310, from the object being outside the surrounded space.

Subsequently, object-serving device 300 is moved to the destination with the predetermined amount of object held by the four object-holding members 310. When the four object-holding members 310 are moved from object-holding position P1 to object release position P2, the predetermined amount of object is put into the destination.

After the four object-holding members 310 are moved from object-holding position P1 to object release position P2, substantially the entirety of each of the members from the tip to the base end is inserted into holding member insert hole 321a. As a result, an object attached to object-holding member 310 is brought into contact with surrounded side 322 so that the object comes off.

Object-serving device 300 can remove objects attached to the four object-holding members 310, without moving object-removing member 321 using by a drive mechanism or the like, in a series of operations by which the object-holding members 310 are moved from object-holding position P1 to object release position P2 relative to object-removing member 321.

In addition, the four connection gears 333 engaged with one pinion gear 332 cause the four object-holding members 310 to move together. In addition, a rotational movement of pinion gear 332 causes rotation shaft 341 to rotate.

In the present embodiment, when the four object-holding members 310 are moved between object-holding position P1 and object release position P2, pinion gear 332 is rotated, for example, 1.25 times. The rotation of pinion gear 332 causes rotation member 342 to rotate by 1.25 times via rotation shaft 341.

When rotation member 342 is rotated 1.25 times, strip-like portions 342b are rotated 1.25 times about rotation shaft 341.

Strip-like portions 342b are rotated at least one time at a position where the portions are in contact with or close to surrounded side 322.

When rotation member 342 is rotated along substantially the entirety of surrounded side 322, an object attached to the surrounded side is swept away. As a result, the whole of the predetermined amount of object held by the four object-holding members 310 is put into the destination.

Object-serving device 300 of the present embodiment makes the same effects as those of object-serving device 100 of embodiment 1. In addition, when drive mechanism 330 causes the four object-holding members 310 to move between object-holding position P1 and object release position P2, the drive mechanism causes rotation member 342 of object-sweeping mechanism 340 to rotate. This rotation sweeps away an object attached to base body 320, so that the whole of a predetermined amount of object held by the four object-holding members 310 are put into the destination. As a result, object-serving device 300 serves the predetermined amount of object to the destination in a stable manner.

In addition, drive mechanism 330 causes the four object-holding members 310 to move between object-holding position P1 and object release position P2, the same drive mechanism causes rotation member 342 of object-sweeping mechanism 340 to rotate. Accordingly, object-serving device 300 of the present embodiment does not need an additional drive mechanism for causing rotation member 342 to rotate. Object-serving device 300, with a simple device configuration, can serve a predetermined amount of object to the destination in a stable manner.

### Embodiment 4

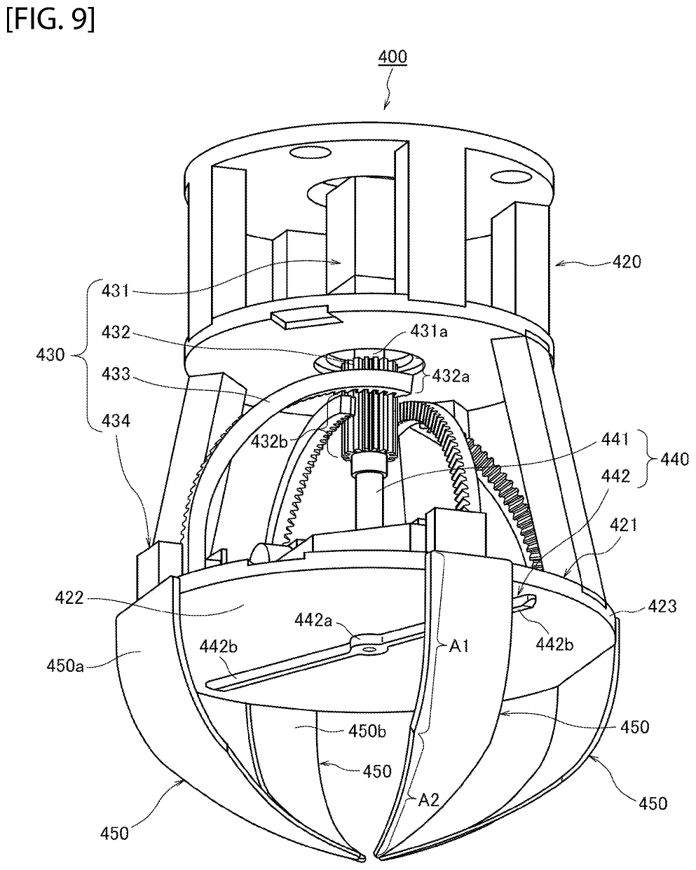

Object-serving device 400 according to embodiment 4 of the present invention will be described with reference to FIG. 9, which is a perspective view of object-serving device 400 according to embodiment 4 of the present invention.

Object-serving device 400 according to embodiment 4 of the present invention differs from the above-mentioned object-serving device 300 according to embodiment 3 of the present invention in the shape of four object-holding members 450. However, object-serving device 400 shares the other configurations with object-serving device 300. The portions and members shared with object-serving device 300 are denoted by corresponding reference numerals in the 400s, and redundant explanation thereof will be omitted.

Object-serving device 400 of the present embodiment includes: four object-holding members 310 configured to move at least between object-holding position P1 and object release position P2; base body 420 to which the four object-holding members 450 are attached such that the object-holding members can be moved; and drive mechanism 430 for driving the four object-holding members 410.

It is of note that object-serving device 400 of the present embodiment is an example of a device including four object-holding member 450. The number of object-holding members 450 may be any number other than four as long as object-holding members 450 can hold an object. For example, the number of object-holding members 450 may be six.

Object-holding member 450 of object-serving device 400 is, for example, a stainless-steel plate. Object-holding member 450 has a shape following a path of movement of the member at object-holding position P1.

In the present embodiment, the path of movement of object-holding member 450 has a substantially arc shape. Object-holding member 450 has an arc shape following a path of movement of the member at object-holding position P1.

Object-holding member 450 has: area A1 from the back end to the central portion in the extension direction, the area having a width larger than those of object-holding members 110, 210, and 310 of embodiments 1 to 3; and tapered area A2 at the tip portion, having a width gradually decreasing toward the tip.

Since object-holding member 450 has wide area A1, the object-holding members 450 have narrow gaps between them at object-holding position P1. Accordingly, the object-holding members 450 keep a soft object or a powdery and highly-liquid object from dropping out of the space surrounded by the members.

Since tapered area A2 at the tip portion has a width gradually decreasing toward the tip, the area is easily inserted into an object.

The four object-holding members 450 are simultaneously moved to object-holding position P1 in different directions. When the tapered tip portions of the object-holding members 450 are inserted and moved to object-holding position P1 along a path of movement, a surrounded space is formed by the members, in which a predetermined amount of object is held.

The four object-holding members 450 are provided with outer peripheral cover (not shown) for removing an object attached to outer surfaces 450a of the members.

The outer peripheral cover is, for example, a substantially cylindrical member made of a stainless-steel. The outer peripheral cover is fixed along outer peripheral surface 423 of object-removing member 421 so as to surround the space above object-removing member 421 (in other words, the space where drive mechanism 430 of object-serving device 400 is provided).

The outer peripheral cover has an inner peripheral surface on which four recesses are provided. The four recesses are spaces formed between outer peripheral surface 423 of object-removing member 421 and the inner surface of the outer peripheral cover. The four recesses allow the movement of object-holding members 450.

When the object-holding members 450 are moved between object-holding position P1 and object release position P2, an object attached to outer surface 450a of object-removing member 421 is brought into contact with the inner surface of the outer peripheral cover so that the object comes off.

The outer peripheral cover is capable of removing an object attached to the outer surfaces of the object-holding members 450 when the members are moved between object-holding position P1 and object release position P2.

The outer peripheral cover is also capable of preventing an object attached to the object-holding members 450 from being brought into the space above object-removing member 421 (in other words, the space where drive mechanism 430 is provided).

The outer peripheral cover prevents an object from attaching to drive mechanism 430. This makes cleaning of drive mechanism 430 easy and improves maintainability.

The inner surface (in particular, near the entrance of object-holding member 450) of the recess may be provided with a sealing material (not shown) made of a resin such as a resin suitable for food. The sealing material prevents object-holding member 450 and the outer peripheral cover of the same material from rubbing against each other to generate metallic powder. The sealing material also facilitates removal of an object attached to object-holding member 450.

Object-serving device 400 of the present embodiment makes the same effects as those of object-serving device 100 of embodiment 1. In addition, the four object-holding members 450 have wide area A1 from the back end to the central portion in the extension direction, so that the object-holding members 450 have narrow gaps between them at object-holding position P1. Accordingly, the object-holding members 450 keep a soft object or a powdery and highly-liquid object from dropping out of the space surrounded by the members. As a result, object-serving device 400 serves a predetermined amount of object to the destination in a stable manner. However, object-serving device 400 having wide area A1 may have difficulty in holding fibrous food such as shredded cabbage. Therefore, it is preferable to design the widths and the shapes of area A1 and area A2 in accordance with the physical property of target food.

It is of note that embodiments 3 and 4 of the present invention are an example of a device in which rotation member 342 or 442 is caused by drive mechanism 330 or 430 to sweep away an object attached to base body 320 or 420. These embodiments may employ a configuration other than rotation member 342 or 442, that is capable of sweeping away an object attached to base body 320 or 420. For example, the embodiments may be provided with a swing member (not shown) or a parallel-moving member for sweeping away an object attached to base body 320 or 420. The swing member or the parallel-moving is caused by the drive mechanism to swing or move parallel at a position where the member is in contact with or close to surrounded side 322 or 422 of object-removing member 321.

The swing member or the parallel-moving member is moved by, for example, a link mechanism connected to drive mechanism 330 or 430.

It is of note that embodiments 3 and 4 of the present invention are an example of a device in which rotation member 342 or 442 is rotated by rotation shaft 341 or 441 connected to pinion gear 332 or 432 (in other words, by mechanical transmission). These embodiments may employ, for example, an electrical transmission mechanism (for example, a mechanism that uses electricity generated by drive mechanism 330 or 430 to rotate rotation member 342 or 442 by electronic transmission). Alternatively, the embodiments may employ another drive mechanism for rotating rotation member 342 or 442.

The foregoing is a description of several embodiments of the present invention. These embodiments are examples of an object-serving device for realizing the technical idea of the present invention. The present invention is not limited to these embodiments and is equally applicable to other embodiments. A part of these embodiments may be omitted, added, or modified. These embodiments may be combined.

It is of note that object-holding member 110, etc. is made of a stainless-steel, as an example. The material of the embodiments is not limited to a stainless-steel. In a case where an object is food, the embodiments are preferably made of a stainless steel or a stainless alloy; however, the material is not limited to these. The embodiments may be made of another type of material having a certain degree of rigidity and suitable for food, such as another metal, a metal alloy, a resin, or ceramics.

### DESCRIPTION OF THE REFERENCE SIGNS

100, 200, 300, 400 . . . Object-serving device
110, 210, 310, 450 . . . Object-holding member
450a . . . Outer surface
450b . . . Inner surface
120, 220, 320, 420 . . . Base body
121, 221, 321, 421 . . . Object-removing member
121a, 221a, 321a . . . Holding member insert hole
322, 422 . . . Surrounded side
423 . . . Outer peripheral surface
130, 230, 330, 430 . . . Drive mechanism
131, 331, 431 . . . Motor
331a, 431a . . . Shaft
132, 332, 432 . . . Pinion gear
132a, 332a, 432a . . . Upper engagement area
132b, 332b, 432b . . . Lower engagement area
133, 333, 433 . . . Connection gear
134, 334, 434 . . . Rotation support arm
134a, 334a . . . Rotational support shaft portion
335 . . . Shaft block
335a . . . Bearing
134b, 334b . . . Connecting portion
134c, 334c . . . Arm portion
340, 440 . . . Object-sweeping mechanism
341, 441 . . . Rotation shaft
342, 442 . . . Rotation member
342a, 442a . . . Center fixing portion
342b, 442b Strip-like portion

1. An object-serving device, comprising:
object-holding members configured to move at least between an object-holding position and an object release position;
a base body to which the object-holding members are attached such that the object-holding members can be moved; and
a drive mechanism for driving the object-holding members, wherein each of the object-holding members has a shape following its path of movement at the object-holding position.

2. The object-serving device according to claim 1, wherein the shape of the object-holding members comprises at least one of a substantially arcuate shape or a substantially linear shape.

3. The object-serving device according to claim 1, wherein at least two or more of the object-holding members are configured to move together.

4. The object-serving device according to claim 1, wherein the base body is provided with an object-removing member for removing an object attached to one of the object-holding members.

5. The object-serving device according to claim 1, further comprising an object-sweeping mechanism for sweeping away an object attached to the base body.
